(19) United States
(12) Patent Application Publication
(10) Pub. No.: US 2023/0342853 A1
(43) Pub. Date: Oct. 26, 2023

(54) ELECTRONIC IMPACT PLATFORM FOR SUSTAINABLE INVESTMENT IN SOCIALLY RESPONSIBLE ENDEAVORS

(71) Applicant: UNIVERSITY HOSPITALS HEALTH SYSTEM, INC., Cleveland, OH (US)

(72) Inventors: Jonathan STAMLER, Cleveland, OH (US); Paul VANVALKENBURGH, Cleveland, OH (US)

(21) Appl. No.: 18/005,066

(22) PCT Filed: Jul. 7, 2021
(86) PCT No.: PCT/US2021/040599

§ 371 Date: Jan. 11, 2023

Related U.S. Application Data
(60) Provisional application No. 63/051,403, filed on Jul. 14, 2020.

(51) Int. Cl. G06Q 40/06; G06Q 30/0279

(52) U.S. Cl. CPC G06Q 40/06; G06Q 30/0279

(57) ABSTRACT

An automated electronic impact platform provides sustainable funding for socially responsible endeavors using investment returns from an impact fund. A first portion of a philanthropic contribution is used to fund charitable activity related to a socially responsible endeavor, while a second portion of a philanthropic contribution is used to invest in an impact fund that invests in commercial activity related to the socially responsible endeavor. As the impact fund generates a financial return, the financial return is recycled back to the contribution stage, whereby the financial return contribution, similarly as the initial philanthropy contribution, is divided into a first portion used to fund charitable activity and a second portion used to re-invest in the impact fund to fund commercial activity.

### RELATED APPLICATIONS

This application claims the benefit of U.S. Provisional Application No. 63/051,403 filed Jul. 14, 2020, the contents of which are incorporated herein by reference.

### TECHNICAL FIELD OF INVENTION

The technology of the present disclosure relates generally to electronic systems and related automated methods for creating and managing philanthropic contributions and impact fund investments for the funding of socially responsible endeavors.

### BACKGROUND

Socially responsible endeavors generally may refer to technological advances that can provide a general benefit to society. An example is the development of new medical technologies, such as new pharmaceuticals, vaccines, medical devices, advanced medical treatments, and the like. Research and development of such new technologies requires substantial financial resources for the benefits to be brought to fruition. In this regard, the vast majority of research and development efforts are unsuccessful, as only a small proportion of projects ultimately prove viable. Although the principles of the current application are described largely in connection with the development of medical technologies, comparable principles may be applied to other socially responsible endeavors, such as for example environmental protection, clean energy technologies, enhanced food production and distribution, affordable housing development, and others.

Because of the benefits to society, socially responsible endeavors often are beneficiaries of charitable or philanthropic contributions. On the other hand, many categories of socially responsible endeavors, and medical technology is a prime example, are often highly profitable when successful. Because of the profit potential, certain categories of socially responsible endeavors also are often beneficiaries of targeted for-profit investment. On the charitable side, donors give charitable or philanthropic contributions to non-profit entities such as universities and hospital systems. Such philanthropic contributions may be provided directly to the non-profit entity, or to a donor advised fund (DAF) that is managed by the non-profit entity or an affiliate financial institution. The non-profit entity then distributes the philanthropic contributions to scholars, scientists, research projects, and other non-profit related entities involved in research and development related to socially responsible endeavors. One aspect of the charitable side of funding is that donor contributions are provided without any financial return to the donor - the contributions effectively become invisible relative to the donors as the contributions are distributed by the non-profit organization to the various research and development projects.

On the for-profit investment side of socially responsible endeavors, investing entities such as individual investing clients, venture capital funds, anchor profit affiliates of non-profit entities, and the like provide financial investments in companies engaged in commercial research and development related to socially responsible endeavors. Many of these companies are small start-up companies focused on a particular product or small group of related products, such as for example a particular pharmaceutical, vaccine, medical device, or other medical treatment. As referenced above, the vast majority of projects will never become viable, although successful projects can be highly profitable so as to financially overcome the numerous failures. Accordingly, investments in socially responsible endeavors typically are pooled into impact funds that invest in a large number of individual commercial entities, such that the occasional success renders the fund profitable despite the vast majority of projects failing. An impact fund generally is an investment fund intended to yield a financial return through investing in socially responsible endeavors that also benefit society (as opposed to more general corporate endeavors).

In conventional operations for funding socially responsible endeavors, the charitable side and the impact fund investment side tend to operate independently of each other. This separation results in inefficiencies by which funding for socially responsible endeavors is not targeted or utilized to maximum benefit.

### SUMMARY OF INVENTION

There is a need in the art, therefore, for an improved system and methods for providing funding for socially responsible endeavors in a more efficient manner. Embodiments of the present application provide an electronic impact platform implemented as an automated computer-based system in which handling of charitable and investment contributions is merged into a sustainable funding stream for socially responsible endeavors. A methodology is electronically implemented to combine sustainable philanthropy with sustainable venture or investment funding. In exemplary embodiments, initial philanthropy contributions are divided between charitable activities and investing in an impact fund managed and distributed by a financial institution (e.g. bank or other fund manager) to invest in commercial entities engaged in socially responsible endeavors, such as for example medical technology development. Accordingly, the impact fund is configured as a socially responsible investment fund that yields a financial return, while a portion of the initial philanthropy contributions is distributed as venture philanthropy that still funds charitable activity. The result is the merging of venture philanthropy with impact fund investment and operation. The initial philanthropic contribution can advance the research enveavors to value inflection adequate for the impact fund to invest such that the impact fund yields a financial return. This leverage can be achieved through electronic systems that provide probabilistic outcomes based on stage of research through the performance of statistical portfolio analyses, such as discrete event simulation, Monte Carlo analysis, and others as are known in the art.

In an exemplary embodiment of a specific electronic implementation of an impact platform, a first portion of a philanthropic contribution is used to promote charitable activity related to a socially responsible endeavor, while a second portion of a philanthropic contribution is used to invest in an impact fund that is engaged in investing in commercial activity related to the socially responsible endeavor. For example, the first portion may be used to de-risk an asset by providing charitable funding (with operational capability) to aid in development of the asset, and the second portion may be used to commercialize the asset to provide a financial return to the impact fund. Capital allocation for de-risking of assets by philanthropy requires a computational feature to ensure alignment with the fund, whereby portfolio analysis techniques are employed to predict return probabilities to provide for sustainable charitable activity and investment in socially responsible endeavors.

Thus, on the front end, the allocation of philanthropy between impact fund and research will be algorithmically determined by portfolio analysis to ensure a financial return suitable for sustainable philanthropy, and may vary over time as such analysis yields different results. As the impact fund generates a financial return, the financial return is recycled back to the contribution stage, whereby the financial return contribution, similarly as the initial philanthropy contribution, is divided into a first portion used to promote the charitable activity and a second portion used to re-invest in the impact fund to promote the commercial activity. The recyled money will be reallocated-to research and fund-- based on a probability assessment for both derisking of non-profit assets and of for-profit returns needed for sustainability. In this manner, a sustainable funding model is established, whereby following the initial philanthropy contribution, recycling financial return contributions from the impact fund over multiple iterations provides a self-sustaining source of funding of the socially responsible endeavor.

In one example implementation, the first potion of each initial philanthropy contribution and each subsequent recycled financial return contribution is 50%, and the second potion of each initial philanthropy and each subsequent recycled financial return contribution is 50%. In such example, the rate of return for recycling is approximately a two-times or doubling return. In this manner, the initial philanthropy contribution and each iteration of the recycled financial return contribution are approximately equal to provide a self-sustaining funding of the socially responsible endeavor. This example presumes that assets can be effectively de-risked for 50% of capital and that the fund will generate two-times or doubling returns. Implementation may vary from this example in scenarios in which assets have a variable cost of de-risking and/or the fund returns are different from doubling returns.

In exemplary embodiments, the impact platform is implemented as a computer-based automated system. A user interface may be employed to set parameters for the distribution of philanthropy contributions between the charitable activity and the impact fund. In general, on the charitable donations side, the user interface may be employed to define a specific set of charitable recipients, and the first portion of the philanthropy contributions automatically is funneled to such specified charitable activity (e.g., scholars, scientists, research projects, etc.) related to a socially responsible endeavor based on stage of development and estimated cost of de-risking. This interface will be needed to funnel philanthropy based on the portfolio probability rather than the individual assets. Similarly, the user interface further may be employed to set parameters for transfer of contribution portions to the impact fund side, such as setting the relative proportions of the first portion for charitable activity and the second portion for investment in the impact fund. The user interface further may be employed on the impact fund side to define a specific set of parameters for investing in commercial entities engaged in research and development of technology related to the socially responsible endeavor, and thus the second portion of the philanthropy contribution automatically is funneled as investments from the impact fund to commercial entities (e.g., startup companies) that satisfy the investment parameters. The recipients and parameters relating to such funding may be updated via the user interface as warranted. The system further automatically tracks the impact fund returns and recycles financial return contributions back to the contribution stage for re-distribution as between charitable funding and impact fund investment. Such redistributions will necessarily be adjusted electronically based on the incoming research and requirements for de-risking and the impact investing landscape that will predict the number, size and scale of expected returns. In this manner, the automation provides efficient, self-sustained funding of the socially responsible endeavor with minimal user effort, and the automated nature of the system ensures efficient distribution of funds that could not otherwise be provided using conventional systems.

The automated, self-sustaining impact platform of the present disclosure has numerous advantages over conventional funding systems. From the donor perspective, the impact of a donation is compounded as portions of recycled return contributions are distributed back into charitable activities. Accordingly, by combining philanthropy with the commercial investment through the impact fund, philanthropy becomes self-sustaining as a portion of the financial return of the impact fund is recycled back into charitable activity. In addition, financial incentives are provided to financial institutions and fund managers through the opportunities to generate additional fees while still promoting socially responsible endeavors. For example, fees may be assessed according to money under management of the impact fund and of the philanthropic contribution, and also for the formation and distribution of funds through the system. Compound impact instruments may include multiple impact initiatives (biotech, high tech, environmental, clean energy, affordable housing), which may be subject to macro-structuring including mutual funds constituting combinations of individual impact funds. In addition, the automated nature of the system ensures efficient distribution of funds that could not otherwise be provided using conventional systems.

An aspect of the invention, therefore, is an electronic, automated impact platform that provides for sustainable charitable funding for funding socially responsible endeavors using investment returns from an impact fund and leverage from non-profit charitable funding that is algorithmically determined to drive size and scale of a corresponding impact fund. In exemplary embodiments, the automated impact platform includes an electronic non-profit module including a first processing device that is configured to receive a philanthropy contribution and transmit the philanthropy contribution electronically; and a central control system including a second processing device configured to perform the steps of: electronically receiving electronic funds corresponding to the philanthropy contribution from the non-profit module; applying a computational simulation to predict a return on investment from an impact fund and automatically dividing the philanthropy contribution into a first portion and a second portion based on a result of the computational simulation; transmitting the first portion electronically to an electronic charitable recipient interface for funding charitable activity in connection with one or more socially responsible endeavors; transmitting the second portion electronically to an electronic impact fund management system for investing in the impact fund to fund commercial entities engaged in commercial activity in connection with one or more socially responsible endeavors; receiving electronically a financial return contribution constituting a return on investment of the second portion from the impact fund management system; and processing the financial return contribution. These transmissions may be adjusted in real time based on progression of the non-profit portfolio using a portfolio analysis technique (e.g. number of drugs effectively de-risked for investment by the fund).

Processing the financial return contribution includes the steps of: applying another computational simulation to predict a return on investment from the impact fund and automatically dividing the financial return contribution into another first portion and another second portion based on a result of the another computational simulation; transmitting the another first portion electronically to another electronic charitable recipient interface for funding charitable activity in connection with one or more socially responsible endeavors; and transmitting the another second portion electronically to the electronic impact fund management system for investing in the impact fund to fund commercial entities engaged in commercial activity in connection with one or more socially responsible endeavors. Applying the computational simulation and the another computation simulation may include the steps of: assessing a stage of non-profit assets and requirements for value creation as measured by investment by the impact fund; modelling returns of the impact fund with respect to any given time to predict the financial return contribution, and automatically dividing the financial return contribution into the another first portion and the another second portion based on the assessments. The second processing device of the central control system further is configured to perform the steps of receiving and processing financial return contributions over multiple iterations to perform a sustainable funding of charitable activity in connection with one or more socially responsible endeavors.

These and further features of the present invention will be apparent with reference to the following description and attached drawings. In the description and drawings, particular embodiments of the invention have been disclosed in detail as being indicative of some of the ways in which the principles of the invention may be employed, but it is understood that the invention is not limited correspondingly in scope. Rather, the invention includes all changes, modifications and equivalents coming within the spirit and terms of the claims appended hereto. Features that are described and/or illustrated with respect to one embodiment may be used in the same way or in a similar way in one or more other embodiments and/or in combination with or instead of the features of the other embodiments. Furthermore, these exemplary cases are based on pharmaceutical development but could be applied to other philanthropically leveraged activities (e.g. low-cost housing Impact funds leveraged by philanthropy to pay rents).

### BRIEF DESCRIPTION OF THE DRAWINGS

FIG. 1 is a drawing depicting an overview of operation of an exemplary impact platform for funding socially responsible endeavors in accordance with embodiments of the present application.

FIG. 2 is a block diagram drawing depicting operative portions of an exemplary computer-based implementation of an impact platform for funding socially responsible endeavors in accordance with embodiments of the present application.

FIG. 3 is a drawing illustrating exemplary sustainability modelling for multiple impact funds, based on device stage and fund duration.

### DETAILED DESCRIPTION OF EMBODIMENTS

Embodiments will now be described with reference to the drawings, wherein like reference numerals are used to refer to like elements throughout. It will be understood that the figures are not necessarily to scale.

Embodiments of the present application provide an improved system and methods for providing funding for socially responsible endeavors in a more efficient manner. Embodiments of the present application provide an electronic impact platform implemented as an automated system in which processing of charitable and investment contributions is merged into a sustainable funding stream for socially responsible endeavors. A methodology is electronically implemented to combine sustainable philanthropy with sustainable venture or investment funding. In exemplary embodiments, initial philanthropy contributions are divided between charitable activities and investment in an impact fund managed and distributed by a financial institution (e.g. bank or other fund manager) to invest in entities engaged in socially responsible endeavors, such as for example start-up companies engaged in medical technology development. Accordingly, the impact fund is configured as a socially responsible investment fund that yields a financial return, while a portion of the initial philanthropy contributions is distributed as venture philanthropy fund charitable activity. The result is the merging of venture philanthropy with impact fund operation, which as further detailed below provides a model for sustainable philanthropy.

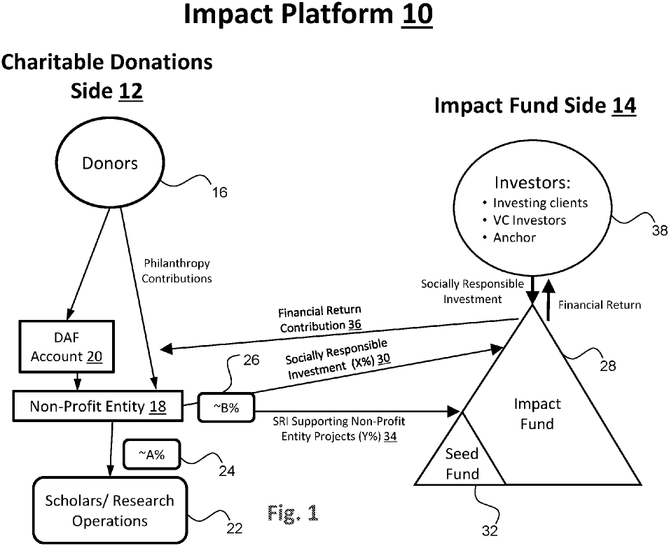

FIG. 1 is a drawing depicting an overview of operation of an exemplary impact platform 10 for funding socially responsible endeavors in accordance with embodiments of the present application. The impact platform 10 is configured to have a charitable donations side 12 and an impact fund side 14. On the charitable donations side 12, donors 16 provide philanthropy contributions to support funding of charitable works relating to one or more socially responsible endeavors. The donors 16 may be individual donors, corporate donors, charitable foundations, and the like as commonly donate charitable contributions. The term “philanthropy contributions”, therefore, is intended to denote wide range of sources of charitable funding that is received on the charitable side 12. Another example of such funding may include funding by public-private partnerships, whereby government funding from associated governmental agencies is combined with private donor and corporate funding to engage in socially responsible endeavors.

As referenced above, an example category of socially responsible endeavors suitable for funding using the impact platform 10 is the development new medical technologies, such as new pharmaceuticals, vaccines, medical devices, advanced medical treatments, and the like. Research and development of such new technologies requires substantial financial resources for the benefits to be brought to fruition. In this regard, the vast majority of research and development efforts are unsuccessful, as only a small proportion of projects ultimately prove viable. Comparable principles may be applied to other socially responsible endeavors that are difficult to bring to fruition, such as for example new technologies pertaining to environmental protection, clean energy technologies, enhanced food production and distribution, affordable housing development, and others.

The philanthropy contributions from donors generally are directed to a non-profit entity 18. Common non-profit entities include hospital systems, universities, charitable foundations, and other like charitable or non-profit organizations that typically fund socially responsible endeavors. The philanthropy contributions may be provided to the non-profit entity 18 either directly or through a donor advised fund (DAF) 20 as are known in the art, which pool philanthropy contributions and then distribute the contributions to various non-profit entities. In conventional funding systems, the philanthropy contributions are then distributed by the non-profit entities 18 to individuals or entities engaging in charitable activities 22 related to socially responsible endeavors. The charitable activities 22 by such individuals or entities may include activity of scholars and scientists and their related research operations engaged in the research and development of new technologies pertaining to socially responsible endeavors. One aspect of the charitable donations side of funding in conventional funding systems is that donor contributions are provided without any financial return to the donor. The contributions effectively become invisible relative to the donors as the contributions are distributed by the non-profit entity to the various research and development projects. In addition, to provide continued funding, repetitive donations are sought to supply an ongoing stream of philanthropy contributions.

In contrast, the impact platform 10 of the current application combines and merges the charitable donations side 12 with the impact fund side 14, which results in a sustainable funding system that provides an ongoing stream of charitable funding without the need for repetitive philanthropy contributions. In this case, the non-profit charitable research activities are aggregated by the system and allocated with philanthropic monies based on stage of development and likelihood of success of a given project. This process is iterative to maximize de-risking of charitable assets. Success-probability algorithms are thus different for venture philanthropy and the impact fund and are assessed together in making capital allocations. In an exemplary embodiment of a specific implementation of an impact platform 10, a first portion 24 of a philanthropic contribution is used to fund charitable activities 22 related to a socially responsible endeavor (i.e., activity by the scholars/scientist and their research operations), while a second portion 26 of a philanthropic contribution is used to invest in an impact fund 28 that invests in commercial activities related to the socially responsible endeavor. For example, the first portion 24 may be used to de-risk assets by providing charitable funding to aid in development of the assets, and the second portion 26 may be used to commercialize the assets to provide a financial return via the impact fund 28.

As referenced above, because the vast majority of development projects for socially responsible endeavors will never become viable, investments in socially responsible endeavors typically are pooled into impact funds that invest in a large number of individual commercial entities, such that the occasional success renders the fund profitable despite the vast majority of projects failing. To minimize these effects, in embodiments of the present application the charitable assets are de-risked with computationally-determined philanthropy to increase the chance of for-profit success. The impact fund 28, therefore, generally is an investment fund intended to yield a financial return through investing in socially responsible endeavors that also benefit society (as opposed to more general corporate endeavors). Many of the companies in which the impact fund 28 invests are small start-up companies focused on a particular product or small group of related products, such as for example a particular pharmaceutical, vaccine, medical device, or other medical treatment. Similarly as with other types of investment funds, impact funds are created and managed in cooperation with major financial institutions, such as banks, hedge funds, brokerages, and other types of fund management entities, which can assess fees related to fund creation, management, and distribution of funding.

Referring more specifically to FIG. 1, the first portion 24 of the philanthropic contribution is directed to the charitable activities 22, and the second portion 26 of the philanthropic contribution is directed to investments 30 in the impact fund 28. In exemplary embodiments as depicted in the example of FIG. 1, the investments are denoted as socially responsible investments (SRI) that are invested in the impact fund 28. There are various categories of, or terms used to denote, socially responsible investments. Examples include MRI (Mission Responsible Investments), ESG (Environment, Social, and Governance) activity, CSR (Corporate Socially Responsible) activity, and other forms of investment in socially responsible activities as are referred to in the art. The impact fund 28 may be an existing impact fund, or the second portion 26 may be used to create a new impact fund. Any suitable proportional division of the first portion 24 and the second portion 26 relative to the initial philanthropic contribution may be employed, and thus FIG. 1 refers to the first portion 24 as being “A%” of the philanthropic contribution and the second portion 26 as being “B%” of the philanthropic contribution. These portions may be determined based on the make-up or nature of the non-profit assets to be de-risked.

As also illustrated in FIG. 1, the impact fund 28 further may include a seed fund component 32. The seed fund 32 may be a fund portion of the impact fund that provides start-up or “seed” funding to new projects. In exemplary embodiments, the seed fund 32 may be related to projects associated with the non-profit entity 18. For example, if the non-profit entity 18 is a health system, the health system may have a for-profit affiliate (entity or provider) that operates to develop and commercialize new medical technologies that in turn can aid in funding the mission of the non-profit health system. Accordingly, the second portion 26 of the philanthropic contribution may be further divided into the investing contribution 30 (e.g., SRI investment) that is invested generally in the impact fund 28, and additional SRI funding 34 for non-profit entity projects that are invested in the seed fund 32. Similarly as with the initial philanthropic contribution, any suitable proportional division of the second portion 26 may be employed, and thus FIG. 1 refers to the more general SRI portion 30 as being “X%” of the second portion 26, and the seed fund portion 34 as being “Y%” of the second portion 26.

As referenced above, the impact fund 28 invests in commercial entities to yield a financial return through investing in socially responsible endeavors that may be profitable and also benefit society. As the impact fund 28 generates a financial return, the financial return is recycled back to the contribution stage. As illustrated in FIG. 1, a financial return contribution 36 is recycled back to the contribution stage as another contribution to the non-profit entity 18, either directly or through the DAF 20. The financial return contribution 36, similarly as the initial philanthropy contribution, is then divided into another first portion 24 used to fund the charitable activity 22, and another second portion 26 used to re-invest in the impact fund 28 to fund the commercial activity. The process may be repeated over continuing, multiple iterations, whereby financial return contributions 36 of the impact fund 28 are recycled back to the contribution stage to provide additional funding for charitable activity and re-investment into the impact fund, which may be utilized for other current projects, new projects, or re-investment in a continuing project. In this manner, a sustainable funding model is established, whereby following the initial philanthropy contribution, repeated iterations of recycling of financial returns from the impact fund as financial return contributions 36 provides a self-sustaining source of funding of the socially responsible endeavors. In addition, the second portion 26 of each iteration of the financial return contribution also may be divided further into SRI funding 34 for the seed fund 32 and SRI funding 30 more generally for the impact fund 28.

Any suitable proportional division to generate the first portion 24 and the second portion 26 may be employed, both as to the initial philanthropy contribution and each iteration of the financial return contribution 36. In one example implementation, the first potion 24 of the initial philanthropic or recycled financial return contribution is 50%, and the second potion 26 of the initial philanthropic or recycled financial return contribution is 50%. In such example, the return for initiating recycling of the financial return contribution is approximately a two-times or doubling return. In this manner, the initial philanthropic contribution and each iteration of the recycled return financial contribution are approximately equal to provide a self-sustaining funding of the socially responsible endeavor. This example presumes that assets can be effectively de-risked for 50% of capital and that the fund will generate two-times or doubling returns. Implementation may vary from this example in scenarios in which assets have a variable cost of de-risking and/or the fund returns are different from doubling returns. More generally, the first portion 24 may be in a range of 10%-90% and the second portion may be 10%-90% (the total of both portions equaling 100% of the initial philanthropy or financial return contribution). The return on investment of the second portion, stemming either from initial philanthropy contributions or financial return contributions, may be at least 1.1 times the second portion.

The automation of the system is implemented through computational analyses to optimize the appropriate divisions of the initial philanthropy contributions and the financial return contributions to fund sustainable philanthropy. The proper proportions are determined computationally and operationally in real time using portfolio analysis techniques that simulate probabilistic returns to determine contribution proportions predicted to provide a return sufficient for sustainable philanthropy. Example portfolio analysis and simulation techniques include discrete event simulation (DES), Monte Carlo simulation analysis, and other simulation techniques as are known in the art. Measures for the returns may include TVPI (total value distributions divided by paid in capital) or DPI (distribution to paid-in capital) measurements, or any suitable measurements of returns as are known in the art.

Similarly, a suitable example division of the SRI investment 30 more generally funding the impact fund 28 and the SRI investment 34 funding the seed fund 32 is 70% to the impact fund generally and 30% to the seed fund based on stage of non-profit assets and time it will take to de-risk for investment for the impact fund. More generally, the SRI investment 30 may be in a range of 50%-90% and the seed fund investment 34 may be in a range of 10%-50% (the total of both portions equaling 100% of the second portion 26).

It also will be appreciated that additional divisions of both the initial philanthropy contributions and financial return contributions may be employed. For example, contributions first may be divided across disciplines of socially responsible endeavors. For example, a contribution may be divided between medical technology development and affordable housing development and rent support. Divisions across multiple disciplines may span any number of such disciplines. Once a contribution is divided based on discipline, the contribution portion for each discipline then may be processed in the manner described above.

The automated, self-sustaining impact platform 10 of the present application has numerous advantages over conventional funding systems. From the donor perspective, the impact of a philanthropy donation is compounded as portions of recycled financial return contributions from the impact fund are distributed back into charitable activities at each iteration of the recycling. Accordingly, by combining philanthropy with the commercial investment through the impact fund, the philanthropy on the charitable donations side becomes self-sustaining as a portion of the financial return is recycled back into the charitable activity. In addition, financial incentives are provided to financial institutions and fund managers through the opportunities to generate additional fees while still promoting socially responsible endeavors. For example, fees may be assessed according to money under management of the impact fund and of the charitable donation, and also for the formation of the impact fund and the distribution of funds through the system. Compound impact instruments may include multiple impact initiatives (biotech, high tech, environmental), which may be subject to macro-structuring including mutual funds constituting combinations of individual impact funds.

As further illustrated in FIG. 1, as part of the general impact platform 10, investment in the impact fund 28 from the charitable donations side 12 may be combined with more traditional for-profit investment on the impact fund side 14. On the impact fund side 14, investing entities 38 such as individual investing clients, venture capital funds, disease foundations, anchor profit affiliates of non-profit entities, and the like also provide socially responsible investment into the impact fund 28 for investing in companies engaged in commercial research and development related to socially responsible endeavors. These more traditional for-profit investments for financial return from the impact fund 28 may be combined with investments from the charitable donations side 12. This combination increases the funding available to enhance the capability of the impact fund 28 to provide funding for entities engaged in socially responsible endeavors, and aggregates capital with different profiles to satisfy different endeavor preferences.

In exemplary embodiments, the impact platform 10 is implemented as a computer-based automated system. A user interface may be employed to set parameters for the distribution of philanthropy contributions between the charitable activity 22 and the impact fund 28. In general, on the charitable donations side 12, the user interface may be employed to define a specific set of charitable recipients, and the first portion of the philanthropy contributions automatically is funneled to such specified charitable activity (e.g., scholars, research projects, etc.) related to a socially responsible endeavor. Similarly, the user interface further may be employed to set parameters for transfer of contribution portions to the impact fund side 14, such as setting the relative proportions of the first portion 24 for charitable activity and the second portion 26 for investment in the impact fund. The user interface further may be employed on the impact fund side 14 to define a specific set of parameters for investing in commercial entities related to the socially responsible endeavor, and thus the second portion of the philanthropy contribution automatically is funneled as investments from the impact fund to commercial entities (e.g., startup companies) that satisfy the investment parameters (which may include investments to the seed fund). The recipients and parameters relating to such funding may be updated via the user interface as warranted. The system further automatically tracks the impact fund returns and progress in charitable (drug development and research) activities, including the generation and providing of reports of results to mangers, donors, investors, and then recycles financial return contributions back to the contribution stage for re-distribution as between charitable funding and impact fund investment. The automation may employ portfolio analyses and simulations as referenced above, to set the proportion divisional for philanthropy contributions and financial return contributions. In this manner, the automation provides efficient, self-sustained funding of the socially responsible endeavor with minimal user effort, and the automated nature of the system ensures efficient distribution of funds that could not otherwise be provided using conventional funding systems.

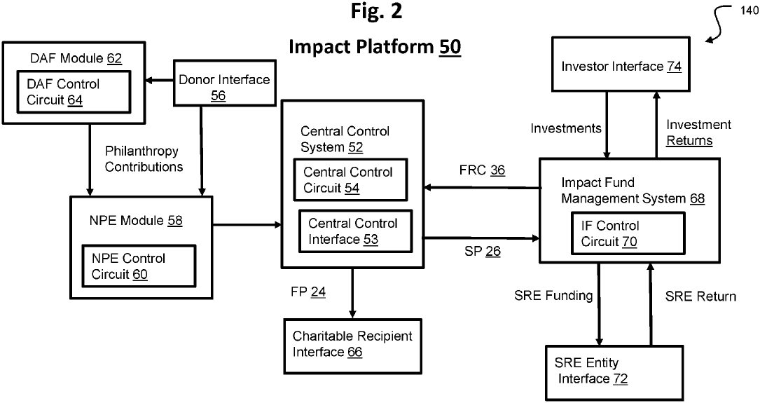

FIG. 2 is a block diagram drawing depicting operative portions of an exemplary computer-based implementation of an impact platform 50 for funding socially responsible endeavors in accordance with embodiments of the present application. In general, the impact platform 50 is controlled through a central control system 52 that employs an electronic control circuit 54 for automated electronic processing of transactions across the impact platform 50. As described above, donors (which may also be groups of entities including for example public-private partnerships) provide philanthropy contributions to support funding of charitable works relating to one or more socially responsible endeavors. In an exemplary electronic implementation as depicted in FIG. 2, the donor philanthropy contributions may be inputted into the system through a donor interface 56. The donor interface 56 is any suitable electronic interface with the capability of electronically processing financial contributions for the electronic transfer of funds (e.g., electronic check processing, credit cards, electronic fund transfers, wire transfers, and the like). The philanthropy contributions from donors generally are directed to a non-profit entity NPE module 58 that includes an NPE control circuit 60 that electronically processes the initial philanthropy contributions. As referenced above in connection with FIG. 1, the philanthropy contributions may be provided to the NPE module 58 either directly, or through a donor advised fund (DAF) module 62, which includes a DAF control circuit 64 that processes the philanthropy contributions and then distributes the contributions to the NPE module 58.

The NPE module 58 in accordance with processing of the NPE control circuit 60 electronically transfers the philanthropy contributions to the central control system 52. As referenced above, the various electronic processing is performed via operation of the central control circuit 54. The central control system 52 automatically operates to divide the philanthropy contributions into the first portion (FP) 24 used to fund charitable activity related to a socially responsible endeavor (i.e., activity by the scholars/ scientists/research operations), and the second portion 26 used to invest in an impact fund that is engaged in commercial activity related to the socially responsible endeavor. As seen in the example of FIG. 2, a charitable recipient may receive or access funds corresponding to the first portion 24 via an electronic charitable recipient interface 66. Funds corresponding to the second portion 26 are electronically transferred to an impact fund management system 68 that includes an impact fund (IF) control circuit 70 to perform the various electronic processing operations related to management of an impact fund.

With such configuration, the initial processing of philanthropy contributions from donation through distribution to chartable recipients and the impact fund is automated. For example, the identities of various non-profit entities, charitable recipients, and impact funds can be entered into the electronic impact platform 50 as processing parameters. Furthermore, the first and second portions for division of the philanthropy contributions also may be set as processing parameters, and further also may be calculated using any suitable portfolio analyses or simulations. Accordingly, once a donation of a philanthropy contribution is received, the system proceeds automatically to implement the electronic transfer of funds in appropriate amounts and to the specified entities in accordance with the processing parameters entered into the system and any subsequent analyses and simulations. To set the various system processing parameters and simulation operations, the central control system 52 further may include a central control interface 53 to input said processing features.

The impact fund management system 68 via the IF control circuit 70 further electronically processes the funds corresponding to the second portion 26 to direct funding to invest in entities engaged in the commercial development of technology related to a socially responsible endeavor. Socially responsible endeavor (SRE) funding is therefore directed to one or more SRE entities -- each using its own algorithm for allocation of philanthropy between non-profit and for-profit activity-- thereby creating a platform to support and manage sustainable pools of philanthropy that are driven by a new impact fund asset class that is itself created from philanthropy. As seen in the example of FIG. 2, a socially responsible endeavor entity may receive or access funds corresponding to the SRE funding via an SRE entity interface 72. Any financial return from the commercial development related to the socially responsible endeavor (SRE return) is electronically transferred back into the impact fund as referenced above, with the processing of the SRE return also being performed by the IF management system 68. Commensurately as described with respect to FIG. 1, the impact fund management system 68 may be created and managed in cooperation with major financial institutions, such as banks, hedge funds, brokerages, and other types of fund management entities. The IF management system 68 further may implement any suitable division of investments as between seed funding and other SRE entities as described above in connection with FIG. 1.

As referenced above, as the impact fund generates a financial return, the financial return is recycled back to the contribution stage. As illustrated in FIG. 2, the financial return contribution (FRC) 36 is recycled by electronic transfer back to the central control system 52. As described above, the financial return contribution 36, similarly as the initial philanthropy contribution, is then divided into another first portion 24 used to fund the charitable activity, and another second portion 26 used to re-invest in the impact fund to fund the commercial activity. These proportions again may be calculated and otherwise revised or updated using any suitable portfolio analyses or simulation techniques (e.g., DES, Monte Carlo, etc.) to ensure a financial return that supports sustainable funding. The process may be repeated over continuing, multiple iterations, whereby financial returns of the impact fund are recycled back to the contribution stage and processed by the central control system to provide additional funding for charitable activity and re-investment into the impact fund. In this manner, the sustainable funding model is established, whereby following the initial philanthropy contribution, repeated iterations of recycling of financial returns from the impact fund as financial return contributions provides a self-sustaining source of funding of the socially responsible endeavors. The recycling also is performed automatically to provide an efficient sustainable funding model, in that once the initial processing parameters are set via the central control interface, the central control system maintains the sustainable funding operation with minimal user input.

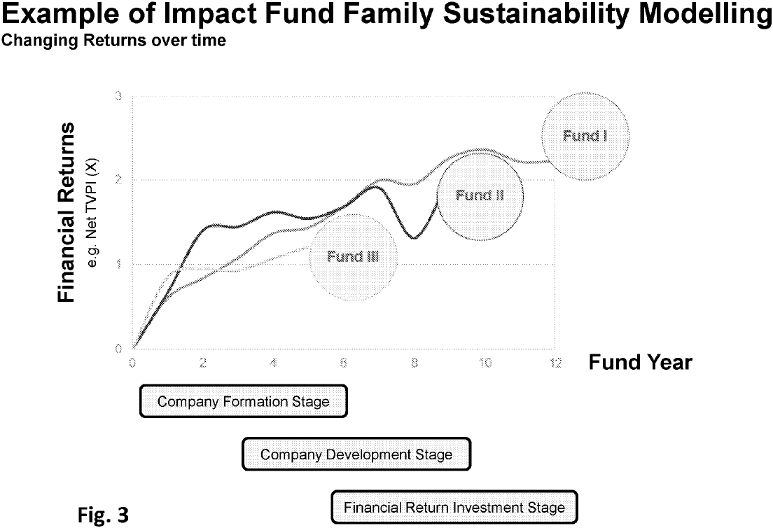

Allocations may vary as described above based on input features, and further divisions of financial return contributions may be updated and revised based on changes in the market place and stage of research. In this regard, FIG. 3 is a drawing illustrating sustainability modelling for multiple impact funds, based on development stage and fund duration. In this example, sustainability modelling is depicted for three funds, with the financial returns (based on TVPlx) being shown as a function of fund year. Different stages of commercial development associated with each fund are shown, and thus it is illustrated how financial returns can vary for different funds, and based on development stage and duration of the fund. This modelling can be utilized to set and/or update, based on changes in market conditions and/or development stage, the proportional divisions of the financial return contributions that have been recycled back to the contribution stage. By automating such calculations based on portfolio analysis using predictive simulations and modelling techniques, a more efficient and effective sustaining funding model is achieved as could otherwise be achieved either manually or using conventional funding systems.

Referring back to FIG. 2, as referenced above, at the various operations of the impact platform, funds are moved between the components electronically. Any suitable manner of electronic transfer of funds may be performed, such as wire transfers, electronic fund transfers, and others as are commonly known and used in the art of financial transactions.

Similarly as described above with respect to FIG. 1, FIG. 2 illustrates that as part of the general electronic impact platform 50, investment in the impact fund from the charitable donations side may be combined with more traditional for-profit investment on the impact fund side. Accordingly, investing entities such as individual investing clients, venture capital funds, anchor profit affiliates of non-profit entities, and the like also provide related investment into the impact fund via processing investments through the impact fund management system 68 for investing in companies engaged in commercial research and development related to socially responsible endeavors. Investments may be inputted into the system, and investment returns distributed, through an investor interface 74. Similarly as the donor interface 56, the investor interface 74 is any suitable electronic interface with the capability of electronically processing financial investments and returns (e.g., electronic check processing, credit cards, electronic fund transfers, wire transfers, and the like).

Each of the control circuits identified as components of the electronic impact platform 50 may include one or more electronic processors, such as a CPU, microcontroller or microprocessor. Among their functions, to implement the features of the present application, the control circuits with electronic processor functionality may comprise an electronic controller that may execute program code embodied as suitable control applications to perform the electronic processing operations described as to the impact platform implementation. It will be apparent to a person having ordinary skill in the art of computer programming, and specifically in application programming for electronic and communication devices, how to program the device to operate and carry out logical functions associated with the control applications. Accordingly, details as to specific programming code have been left out for the sake of brevity. Control application programming and software may be stored in the various control circuits within a non-transitory computer readable medium component of said control circuits, such as random access memory (RAM), a read-only memory (ROM), an erasable programmable read-only memory (EPROM or Flash memory), or any other suitable medium. Control applications and related software may be stored internally within the control circuit components, and additionally or alternatively may be stored in one or more additional and separate computer-readable memory devices. Also, while programming code may be executed by the control circuits in accordance with an exemplary embodiment, such controller functionality could also be carried out via dedicated hardware, firmware, software, or combinations thereof, without departing from the scope of the invention.

The interface components also may include any suitable control circuity, non-transitory computer-readable media, and programming software or code as warranted to implement the electronic interface functionality, including as to the electronic processing of financial contributions and returns. The interface components also may include any input/output (I/O) devices as may be warranted to implement the electronic interface functionality. Such l/O devices may include, for example without limitation, any suitable keyboards, keypads, displays, touchscreens, audio input and output devices, and other suitable I/O devices as are commonly employed in computer-based user interfaces. In addition, although the various components of the impact platform 50 are illustrated as unitary components, the electronic implementation may be integrated or distributed among multiple electronic components as may be warranted for any particular circumstances.

As referenced above, the central control interface may be configured to receive an input of processing parameters for processing the philanthropy contributions and the financial return contributions. Processing parameters may include, for example, one or more of charitable recipient identities, proportional amounts of the first portion and the second portion relative to the philanthropy contribution, proportional amounts of the another first portion and the another second portion relative to the financial return contribution, portfolio analyses or simulations to be performed for setting or revising the proportional divisions.

The central control interface further may be configured to receive an input of processing parameters that define parameters relating to investments to be made through the impact fund. The central control interface may be utilized to set investment parameters for investments by the impact fund in entities engaged in commercial activity with respect to socially responsible endeavors. Investment parameters include such features as numbers of entities which are included to receive investments, amounts of investments, and characteristics of the commercial activity. In an example of the establishment of portfolio parameters of an impact fund for promoting pharmaceutical technologies as the socially responsible endeavor, for pharmaceutical technologies investing parameters may include parameters associated with investments at the various stages of pharmaceutical development. Comparable interfaces may be designed specifically suited for any given socially responsible endeavor.

Although the invention has been shown and described with respect to a certain embodiment or embodiments, equivalent alterations and modifications may occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein exemplary embodiment or embodiments of the invention. In addition, while a particular feature of the invention may have been described above with respect to only one or more of several embodiments, such feature may be combined with one or more other features of the other embodiments, as may be desired and advantageous for any given or particular application.

What is claimed is:

1. An automated impact platform for funding socially responsible endeavors comprising:
an electronic non-profit module including a first processing device that is configured to receive and calculate a philanthropy contribution and electronically transmit the philanthropy contribution; and
a central control system including a second processing device configured to perform the steps of:
electronically receiving the fund transfer corresponding to the philanthropy contribution from the non-profit module;
applying a computational simulation to predict a return on investment from an impact fund and automatically dividing the philanthropy contribution into a first portion and a second portion based on a result of the computational simulation;
transmitting the first portion electronically to an electronic charitable recipient interface for funding charitable activity in connection with one or more socially responsible endeavors;
transmitting the second portion electronically to an electronic impact fund management system for investing in the impact fund to fund commercial entities engaged in commercial activity in connection with one or more socially responsible endeavors;
receiving electronically a financial return contribution constituting a return on investment of the second portion from the impact fund management system; and processing the financial return contribution by the steps of:
applying another computational simulation to predict a return on investment from the impact fund automatically dividing the financial return contribution into another first portion and another second portion based on a result of the another computational simulation;
transmitting the another first portion electronically to another electronic charitable recipient interface for funding charitable activity in connection with one or more socially responsible endeavors; and
transmitting the another second portion electronically to the electronic impact fund management system for investing in the impact fund to fund commercial entities engaged in commercial activity in connection with one or more socially responsible endeavors.

2. The automated impact platform of claim 1, wherein the second processing device of the central control system further is configured to perform the steps of receiving and processing financial return contributions over multiple iterations to perform a sustainable funding of charitable activity in connection with one or more socially responsible endeavors.

3. The automated impact platform of claim 1, wherein the first portion is 10-90% of the philanthropy contribution and the second portion is 10-90% of the philanthropy contribution.

4. The automated impact platform of claim 1, wherein the another first portion is 10-90% of the financial return contribution and the another second portion is 10-90% of the financial return contribution.

5. The automated impact platform of claim 1, wherein the first portion and the another first portion are a same proportion relative respectively to the philanthropy contribution and the financial return contribution, and the second portion and the another second portion are a same proportion relative respectively to the philanthropy contribution and the financial return contribution.

6. The automated impact platform of claim 1, wherein the first portion and the another first portion are different proportions relative respectively to the philanthropy contribution and the financial return contribution, and the second portion and the another second portion are different proportions relative respectively to the philanthropy contribution and the financial return contribution.

7. The automated impact platform of claim 1, wherein the return on investment of the second portion is at least 1.1 times the second portion.

8. The automated impact platform of claim 2, wherein as to each iteration, a return on investment of the another second portion is at least 1.1 times the another second portion.

9. The automated impact platform of claim 1, wherein the second processing device of the central control system further is configured to divide the second portion into a mission related investment portion and a seed funding investment portion, wherein the seed funding portion funds a seed fund component of the impact fund.

10. The automated impact platform of claim 9, wherein the mission related investment portion is 10-50% of the second portion and the seed funding portion is 10-50% of the second portion.

11. The automated impact platform of claim 2, wherein the second processing device of the central control system further is configured to divide the second portion into a mission related investment portion and a seed funding investment portion, wherein the seed funding portion funds a seed fund component of the impact fund; and
wherein as to each iteration, the second processing device of the central control system further is configured to divide the another second portion into another mission related investment portion and another seed funding investment portion, wherein the another seed funding portion funds the seed fund component of the impact fund.

12. The automated impact platform of claim 11, wherein as to each iteration, the another mission related investment portion is 10-90% of the another second portion and the seed funding portion is 10-90% of the another second portion.

13. The automated impact platform of claim 1, wherein the central control system further includes an electronic central control interface that is configured to receive an input of processing parameters for processing the philanthropy contribution and the financial return contribution;
wherein the processing parameters include one or more of charitable recipient number or identities, proportional amounts of the first portion and the second portion relative to the philanthropy contribution, and proportional amounts of the another first portion and the another second portion relative to the financial return contribution; and
wherein the processing parameters further include parameters for investments by the impact fund in entities engaged in commercial activity with respect to one or more socially responsible endeavors.

14-16. (canceled)

17. The automated impact platform of claim 1, further comprising an electronic donor interface configured to receive a philanthropy contribution from a donor and electronically transmit the philanthropy contribution to the non-profit entity module.

18-21. (canceled)

22. The automated impact platform of claim 1, wherein the first processing device further is configured assess a requirement for leverage comprising an amount of funds needed to achieve investment by the impact fund.

23. The automated impact platform of claim 1, wherein applying the computational simulation and the another computation simulation includes the steps of:
assessing a stage of non-profit assets and requirements for value creation as measured by investment by the impact fund;
modelling returns of the impact fund with respect to any given time to predict the financial return contribution, and
automatically dividing the financial return contribution into the another first portion and the another second portion based on the assessments.

24. An automated method for funding socially responsible endeavors comprising the steps of:
electronically receiving and calculating a philanthropy contribution and electronically transmitting the philanthropy contribution to a central control system;
wherein the central control system perform the steps of:
electronically receiving the fund transfer corresponding to the philanthropy contribution;
applying a computational simulation to predict a return on investment from an impact fund and automatically dividing the philanthropy contribution into a first portion and a second portion based on a result of the computational simulation;
transmitting the first portion electronically to an electronic charitable recipient interface for funding charitable activity in connection with one or more socially responsible endeavors;
transmitting the second portion electronically to an electronic impact fund management system for investing in the impact fund to fund commercial entities engaged in commercial activity in connection with one or more socially responsible endeavors;
receiving electronically a financial return contribution constituting a return on investment of the second portion from the impact fund management system; and
processing the financial return contribution by the steps of:
applying another computational simulation to predict a return on investment from the impact fund and automatically dividing the financial return contribution into another first portion and another second portion based on a result of the another computational simulation;
transmitting the another first portion electronically to another electronic charitable recipient interface for funding charitable activity in connection with one or more socially responsible endeavors; and
transmitting the another second portion electronically to the electronic impact fund management system for investing in the impact fund to fund commercial entities engaged in commercial activity in connection with one or more socially responsible endeavors.

25. The automated method of claim 24, wherein the central control system further is configured to perform the steps of receiving and processing financial return contributions over multiple iterations to perform a sustainable funding of charitable activity in connection with one or more socially responsible endeavors.

26-40. (canceled)

41. The automated method of claim 24, wherein applying the computational simulation and the another computation simulation includes the steps of:
assessing a stage of non-profit assets and requirements for value creation as measured by investment by the impact fund;
modelling returns of the impact fund with respect to any given time to predict the financial return contribution, and
automatically dividing the financial return contribution into the another first portion and the another second portion based on the assessments.

42. A non-transitory computer readable storing program code, which when executed by a computer performs the steps of:
electronically receiving and calculating a philanthropy contribution and electronically transmitting the philanthropy contribution to a central control system;
wherein the central control system executes the program code to perform the steps of:
electronically receiving the fund transfer corresponding to the philanthropy contribution;
applying a computational simulation to predict a return on investment from an impact fund and automatically dividing the philanthropy contribution into a first portion and a second portion based on a result of the computational simulation;
transmitting the first portion electronically to an electronic charitable recipient interface for funding charitable activity in connection with one or more socially responsible endeavors;
transmitting the second portion electronically to an electronic impact fund management system for investing in the impact fund to fund commercial entities engaged in commercial activity in connection with one or more socially responsible endeavors;
receiving electronically a financial return contribution constituting a return on investment of the second portion from the impact fund management system; and
processing the financial return contribution by the steps of:
applying another computational simulation to predict a return on investment from the impact fund and automatically dividing the financial return contribution into another first portion and another second portion based on a result of the another computational simulation;
transmitting the another first portion electronically to another electronic charitable recipient interface for funding charitable activity in connection with one or more socially responsible endeavors; and
transmitting the another second portion electronically to the electronic impact fund management system for investing in the impact fund to fund commercial entities engaged in commercial activity in connection with one or more socially responsible endeavors.
